(19) United States
(12) Patent Application Publication
(10) Pub. No.: US 2026/0104527 A1
(43) Pub. Date: Apr. 16, 2026

(54) SYSTEM FOR INTEGRATING AND AUTOMATING FAULT INTERPRETATION TO FAULT MODELLING WORKFLOWS

(71) Applicant: SCHLUMBERGER TECHNOLOGY CORPORATION, Sugar Land, TX (US)

(72) Inventors: Aaron ALEE, Petaling Jaya (MY); Matthew ELLWOOD, Lysaker (NO); Shaan DHUMALE, Montpellier (FR); Amaud LEVANNIER, Montpellier (FR); Stewart SMITH, Stavanger (NO); Surender MANRAL, Stavanger (NO); Guido VAN DER HOFF, Stavanger (NO)

(21) Appl. No.: 19/112,979

(22) PCT Filed: Sep. 18, 2023
(86) PCT No.: PCT/US2023/074497

§ 371 Date: Mar. 19, 2025

Related U.S. Application Data
(60) Provisional application No. 63/376,133, filed on Sep. 19, 2022.

(51) Int. Cl. G01V 1/50

(52) U.S. Cl. CPC G01V 1/50; G01V 2210/324; G01V 2210/642; G01V 2210/66; G01V 2210/74

(57) ABSTRACT

Methods and systems for geological fault modeling are presented. The methods comprise: receiving interpretation data associated with one or more geological faults based on extracted data from a geological site; optimizing the interpretation data using one or more formatting operations associated with a signal processing module; generating one or more gridding representations of the interpretation data using the formatted interpretation data; executing, using the one or more gridding representations of the interpretation data, one or more inference operations based on one or more fault relationships associated with the formatted data to generate a fault model; executing, using the fault model, one or more of a sensitivity operation or an uncertainty analysis operation based on one or more parametric configurations of the fault model during a simulation to generate output data; and initiating generation of a visualization associated with the one or more geological faults based on the output data.

### CROSS-REFERENCE TO RELATED APPLICATIONS

This application claims priority to U.S. Provisional Patent App. No. 63/376,133, filed Sep. 19, 2022, and entitled “System For Integrating And Automating Fault Interpretation To Fault Modelling Workflows,” which incorporates by reference, U.S. Provisional Patent App. No. 63/295,784, filed Dec. 31, 2021, all of which are hereby incorporated in their entirety.

### BACKGROUND

A geologically coherent fault model is relevant for conducting optimal seismic fault interpretation and modeling. The seismic fault interpretation process may be necessary to generate input data required to build such a fault model. However, traditional methods of seismic fault interpretation are manual, time-consuming, inefficient, error-prone, and are often identified as a focus area when seeking to improve workflow efficiency for seismic fault interpretation. In particular, a number of seismic modeling tools that attempt to address the above noted challenges focus on the output of interpretation objects, and not on their capacity for broader data consumption and processing in downstream workflows. Such applications are therefore not aptly designed to be optimally integrated into automated workflows, nor are these technologies designed to prepare data in a coherent manner for consumption between applications. A further shortcoming of such workflows is their lack of uncertainty or scenario handling. Consequently, users (e.g., domain scientists) are faced with further, efforts including, but not limited to; processing the resulting interpretation data through third party data optimization programs, data flow management, and onerous preparation steps for consumption in applications designed to construct the fault model.

### SUMMARY

The disclosed technology relates to an integrated and automated fault interpretation-to-fault modelling solution that includes a component of a wider, cloud-based software application (e.g., An application system for integrating and automating subsurface geology workflows). This technology addresses limitations associated with coupling automated interpretation using machine learning techniques with automated subsurface modelling. The workflows disclosed together with corresponding domain data may be presented in a geospatial context or in a multi-dimensional (e.g., 3-dimensional) visualization canvas.

The purpose of fault modeling includes building or generating a representation or a model(s) of subsurface geological discontinuities, often manifested as a network at reservoir scale, herein referred as a fault framework. The resulting model(s) allow a more enhanced definition of interpreted faults in that they embed knowledge of a relationship between truncating faults in data structures associated with said model(s) and may be represented by a multi-dimensional (e.g., 3-dimensional) surface object that can be parameterized to adapt its geometry to reflect more completely the subsurface discontinuities. Fault frameworks may be heavily influential on the reservoir flow behavior thereby having a material impact on operational decisions that are taken during a field development plan.

Disclosed are methods, systems, and computer programs for fault modeling of a geological formation. According to an embodiment, a method for fault modeling of a geological formation comprises: receiving interpretation data associated with one or more geological faults based on extracted data from a geological site derived from one or more sensors deployed at the geological site; optimizing the interpretation data using one or more formatting operations associated with a signal processing module; generating one or more gridding representations of the interpretation data using the formatted interpretation data; and executing, using the one or more gridding representations of the interpretation data, one or more inference operations based on one or more fault relationships associated with the formatted data to generate a fault model. The method further includes executing, using the fault model, one or more of a sensitivity operation or an uncertainty analysis operation based on one or more parametric configurations of the fault model during a simulation to generate output data; and initiating generation of a multi-dimensional visual canvas associated with the one or more geological faults based on the output data.

In another embodiment, a system and a computer program can include or execute the method described above. These and other implementations may each optionally include one or more of the following features. The one or more formatting operations, according to one embodiment, comprise at least one of: a splitting operation on data associated with fault patches within parameter constraints of the interpretation data; a merging operation on data associated with fault patches within parameter constraints of the interpretation data; a filtering operation on the interpretation data to remove noisy components; and a decimation operation to sample certain specific data components of the interpretation data. Furthermore, executing one or more of the sensitivity operation or uncertainty analysis operation comprises perturbing one or more parameters of the model to determine one or more outcomes for the extracted data. Moreover, the one or more parameters discussed above may include at least one of: a fault probability input threshold parameter indicating range data associated with input fault cube samples associated with the one or more geological faults; an azimuth sector size parameter indicating data of individual sectors associated with the one or more geological faults; and an azimuth sector overlap parameter indicating of one or more overlaps between azimuth sectors associated with the one or more geological faults. According to some embodiments, the one or more parameters include at least one of: a planarity threshold parameter indicating threshold data that describes the one or more geological faults as geometrically consistent; a minimum fault size (per sector) parameter indicating data of a minimum fault size in number of samples associated with the one or more geological faults; and a minimum overlap parameter indicating data of a minimum amount, by percentage, that the one or more geological faults in adjacent sectors must overlap by to be considered for merging operations.

According to some implementations, one or more of the sensitivity operation or the uncertainty operation comprises quantifying one or more characteristics associated with the fault model. In addition, the one or more characteristics associated with the fault model can comprise attribute data that enable: application of a screening process to a large ensemble of fault models; and execution of a ranking process or a sorting processes using the large ensemble of models based on the one or more characteristics. Furthermore, the one or more characteristics can comprise one or more of: isolated fault proportion data associated with the one or more geological faults; fault topology distribution data associated with the one or more geological faults; and fault size distribution data associated with the one or more geological faults. According to one embodiment, the one or more gridding representations include triangle mesh representations. The one or more gridding representations can include hexcell representations. In addition, the multi-dimensional visualization can comprise a 2-dimensional and/or a 3-dimensional visual canvas associated with the one or more geological fault according to some embodiments.

The present disclosure presents aspects that comprise a wider workflow required to construct a subsurface framework: fault interpretation and fault modelling. These serve as building blocks for constructing a fault framework model as further discussed in the detailed description. The process of fault interpretation and fault modelling may be inherently linked, but rarely integrated in most technologies in the seismic space. This solution alleviates many of the limitations faced by users (e.g., domain scientists) by integrating and automating fault interpretation and fault modelling. To achieve this, domain science processes are used in combination with automated data optimization procedures to generate coherent and robust fault model(s) in an accelerated (e.g., real-time or near real-time) and efficient manner.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 shows an exemplary high-level workflow for generating fault interpretation data.

FIG. 2 shows a cross-sectional view of a resource site for which the process of FIG. 1 may be executed.

FIG. 3 shows a high-level networked system illustrating a communicative coupling of devices or systems associated with the resource site of FIG. 2.

FIG. 4 shows an exemplary detailed workflow for generating fault interpretation data.

FIG. 5 provides an exemplary workflow for methods, systems, and computer programs for fault modeling of a geological formation.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to the some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. More specifically, the systems and methods presently disclosed may be applicable to exploring resources such as oil, natural gas, water, and Salar brines.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, or resource data, etc., is sufficiently accurate.

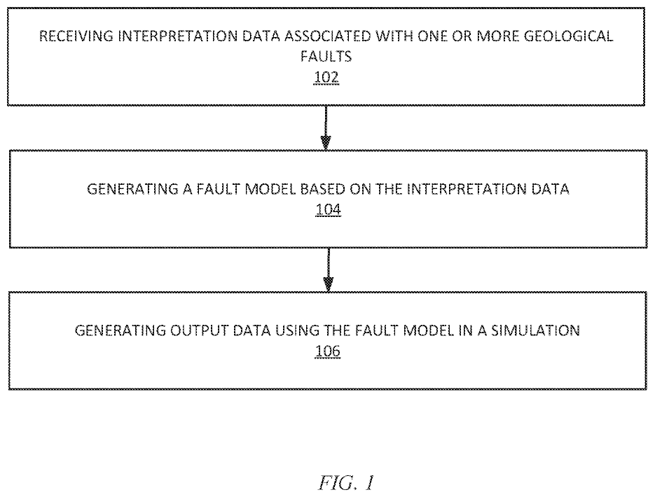

FIG. 1 provides methods and systems for geological fault modeling. The methods comprise receiving, at block 102, interpretation data associated with one or more geological faults based on extracted data from a geological site. The methods may also comprise optimizing the interpretation data using one or more formatting operations associated with a signal processing module. In one embodiment, the methods further comprise generating one or more gridding representations (e.g., triangle mesh representations and/or hexcell representations, or other gridding solutions) of the interpretation data using the formatted interpretation data. The methods may also comprise executing, using the one or more gridding representations (e.g., triangle mesh representations and/or hexcell representations, or other gridding solutions) of the interpretation data, one or more inference operations based on one or more fault relationships associated with the formatted data to generate, at block 104, a fault model. Using the fault model, the methods may execute one or more of a sensitivity operation or an uncertainty analysis operation based on one or more parametric configurations of the fault model during a simulation to generate, at block 106, output data. This output data may be used to initiate generation of a visualization associated with the one or more geological faults.

### Resource Site

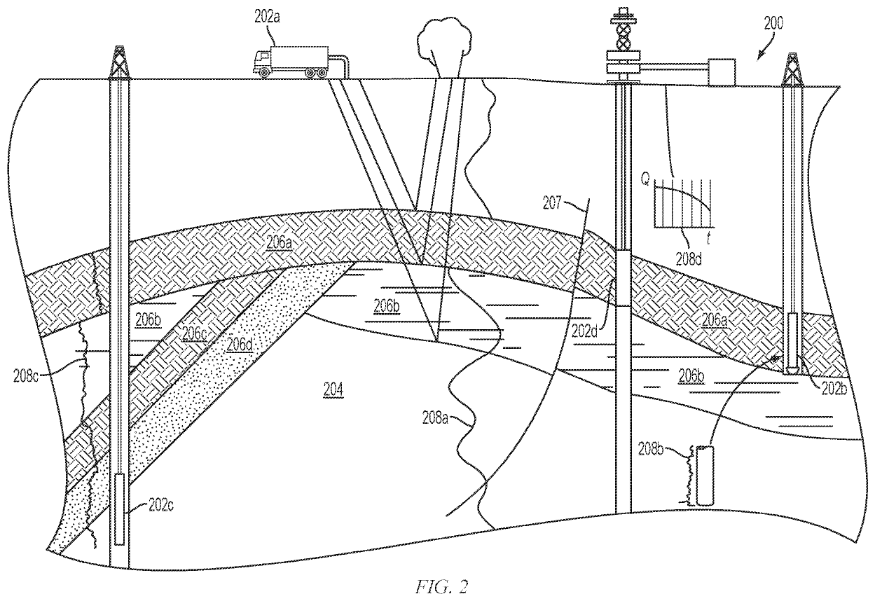

FIG. 2 shows a cross-sectional view of a resource site 200 for which the processes described in FIG. 1 may be executed. While the illustrated resource site 200 represents a subterranean formation, the resource site, according to some embodiments, may be below water bodies such as oceans, seas, lakes, ponds, wetlands, rivers, etc. According to one embodiment, various measurement tools capable of sensing one or more parameters such as seismic two-way travel time, density, resistivity, production rate, etc., of a subterranean formation and/or geological formations may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the oil field 200 may contain a variety of geological structures and/or formations, sometimes having extreme complexity. In some locations of a given geological structure, for example below a water line relative to the given geological structure, fluid may occupy pore spaces of the formations. Each of the measurement devices may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, and/or other parameters of operations as further discussed below.

Sensors may be positioned about the oil field 200 to collect data relating to various oil field operations, such as sensors deployed by the data acquisition tools 202. The sensor may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the formation, wellbore, formation fluid/gas, wellbore fluid, gas/oil/water comprised in the formation/wellbore fluid, or any other suitable sensor. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high resolution result set used to, for example, generate a resource model. In other embodiments, test data or synthetic data may also be used in developing the resource model via one or more simulations such as those discussed in association with the flowcharts presented herein.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of Schlumberger); induction sensors such as Rt Scanner™ (mark of Schlumberger), multifrequency dielectric dispersion sensor such as Dielectric Scanner™ (mark of Schlumberger); acoustic tools including sonic sensors, such as Sonic Scanner™ (mark of Schlumberger) or ultrasonic sensors, such as pulse-echo sensor as in UBI™ or PowerEcho™ (marks of Schlumberger) or flexural sensors PowerFlex™ (mark of Schlumberger); nuclear sensors such as Litho Scanner™ (mark of Schlumberger) or nuclear magnetic resonance sensors; fluid sampling tools including fluid analysis sensors such as InSitu Fluid Analyzer™ (mark of Schlumberger); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

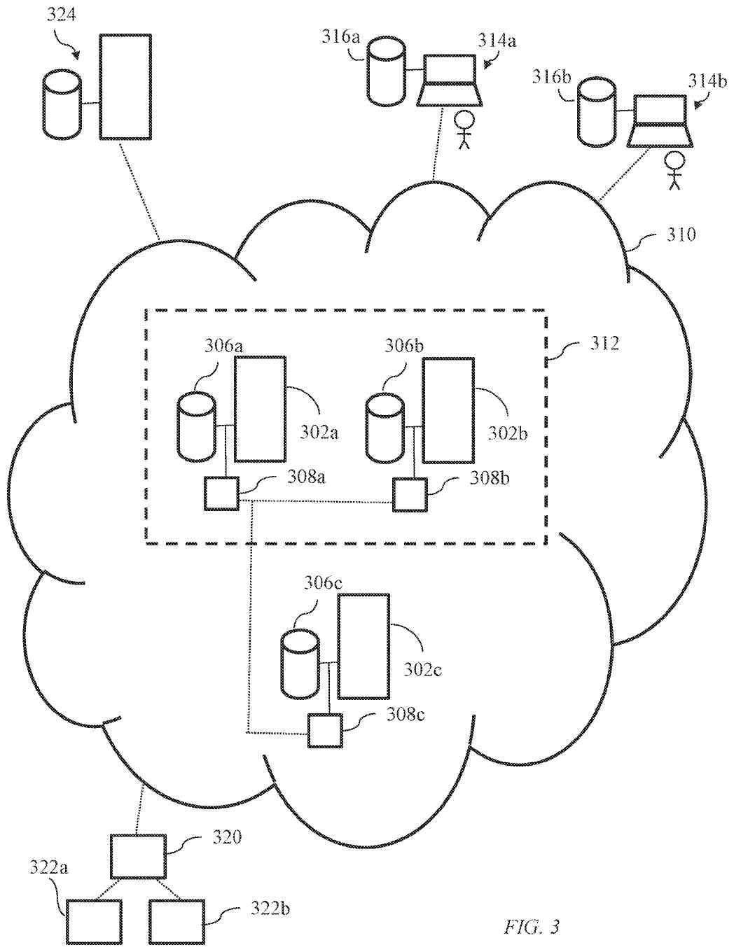

Computer facilities such as those discussed in association with FIG. 3 may be positioned at various locations about the resource site 200 (e.g., a surface unit) and/or at remote locations. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the oil field 200. In one embodiment, the data is stored in separate databases, or combined into a single database.

### High-Level Networked System

FIG. 3 shows a high-level networked system diagram illustrating a communicative coupling of devices or systems associated with the resource site 200. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the oil field 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be communicatively coupled to the one or more servers of the cloud-computing platform 310. The user terminals 314 may be client terminals or expert terminals, enabling collaboration between clients and experts through the system of FIG. 3.

The system of FIG. 3 may also include at least one or more oil fields 200 having, for example, a set of terminals 320, each including at least a processor, a memory, and a communication device for communicating with other devices communicatively coupled to the cloud-computing platform 310. The resource site 200 may also have one or more sensors (e.g., one or more sensors described in association with FIG. 2) or sensor interfaces 322a and 322b communicatively coupled to the set of terminals 320 and/or directly coupled to the cloud-computing platform 310. In some embodiments, data collected by the one or more sensors/sensor interfaces 322a and 322b may be processed to generate one or more resource models or one or more resolved data sets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 may also be communicatively coupled to the set of terminals 320 and or communicatively coupled directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be communicatively coupled to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing and/or application specific integrated circuits.

Further, the steps in the flowcharts described below may be implemented by running one or more functional modules in an information processing apparatus such as general-purpose processors or application specific chips, such as ASICs, FPGAs, PLDs, GPUS, or other appropriate devices associated with the system of FIG. 3. For example, the flowchart of FIG. 1 as well as the flowcharts below may be executed using a signal processing engine stored in memory 306a, 306b, or 306c such that the signal processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### Embodiments

The disclosed technology provides an efficient approach for automatic generation and/or construction of a modeled representation of a geological fault and fault framework model in real-time or near real-time using interpretation data associated with one or more geological faults. Interpretation data associated with one or more geological faults may be obtained using, for example, a data extraction process (e.g., Bounaim, A., Boe, T. H, Athmer, W., Sonneland, L, Knoth, O., 2013 Large Fault Extraction Using Point Cloud Approach to a Seismic Enhanced Discontinuity Cube, Conference Proceedings, 75th EAGE Conference & Exhibition incorporating SPE EUROPEC) or some other extraction application or system deployed on a seismic attribute volume designed to predict the likelihood of fault occurrence. According to some embodiments, raw seismic data associated with one or more geological faults comprised in a resource site (or some other geological sites) may be captured by one or more sensors with the data extraction process being applied to extract relevant data from the raw seismic data. Outputs (e.g., interpretation data) from the extraction step may be automatically processed or otherwise optimized via one or more formatting operations, by a formatting module of the signal processing engine, for consumption by one or more modeling modules of the signal processing engine. Exemplary formatting operations include: automatically executing a splitting operation and/or merging operation on data associated with fault patches within parameter constraints of the interpretation data; executing a filtering operation on said data (e.g., interpretation data) to remove noisy components; and executing a decimation operation to sample certain specific data components of said data (e.g., interpretation data). The one or more modeling modules of the signal processing engine may use the formatted data to subsequently generate or automatically construct, leveraging a set of domain science processes, a series of output gridding representations (e.g., triangle mesh representations and/or hexcell representations, or other gridding solutions associated with the interpretation data. The one or more modeling modules may further infer fault relationships associated with the formatted data and based on the output gridding representations (e.g., triangle mesh representations and/or hexcell representations, or other gridding solutions) and apply truncation rules as the case may require, to generate a model (e.g., modeled gridding representations or fault model) with a specific resolution, a specific data-fit tolerance, and an established fault-to-fault contact lines associated with the extracted data.

Sensitivity operations on the various parametric configurations and/or input attribute volumes associated with the one or more models may be automatically tested (e.g., executed in one or more simulations) based on uncertainty data associated with the seismic attribute volume and/or the parameter set-up of the model. The disclosed technological solution enables generation of one or more output data using the model such that the one or more output data indicates one or more visualizations that represent one or more geological fault frameworks. In one embodiment, the one or more visualizations comprise a multi-dimensional (3-dimensional visual canvas associated with the one or more geological faults for display on a graphical user interface device. This beneficially provides confidence data that inform users (e.g., domain scientist) in real-time or near real-time based on the testing of the one or more models at early stages of geological assessment operations. Another advantage provided by the disclosed solution relates to the significant reduction of cognitive load (amount of working memory resources of users) required to generate accurate fault models as the disclosed processes (e.g., sensitivity testing operations associated with simulation operations on the one or more models) cannot be feasibly performed mentally or in real-time or near real-time by a user (e.g., a person). According to some embodiments, the generated output data inform or otherwise regulate, guide, or facilitate execution of control operations associated with exploratory activities at resource sites with one or more faults. In one embodiment, the output data is associated with control parameters are used to initiate control operations on one or more equipment at the resource site such as controlling drill bit rate of operation, controlling a fluid valve, etc.

Sensitivity operations and uncertainty analysis operations on the one or more models may be undertaken, using one or more modules of the signal processing engine, by perturbing different parameters of the model and may be used to inform the fault extraction process and may be influential in determining unique outcomes for any given extracted data. Parameters tested or perturbed during sensitivity and/or uncertainty analysis include one or more of the following:
a fault probability input threshold parameter indicating the range data associated with input fault cube samples (associated with one or more geological faults) to be included on the overall geometric analysis and subsequent fault extractions;
an azimuth sector size parameter indicating data of individual sectors (associated with one or more geological faults) used to subdivide the overall azimuth range within which faults are segmented based on one or more changes to the overall azimuth;
an azimuth sector overlap parameter indicating of one or more overlaps between azimuth sectors (associated with one or more geological faults) where adjacent faults can be identified for merging;
a planarity threshold parameter indicating threshold data that describes faults (e.g., one or more geological faults) as geometrically consistent and whereby faults are split. Fault samples below this value are excluded to produced isolated faults;
a minimum fault size (per sector) parameter indicating data of a minimum fault size in number of samples (associated with the one or more geological faults) that are allowed per azimuth sector. Fault patches less than this value are discarded and not considered in subsequent merging.
a minimum overlap parameter indicating data of a minimum amount (e.g., percentage amount) that faults (e.g., one or more geological faults) in adjacent sectors must overlap by to be considered for merging operations.

During the sensitivity and uncertainty analysis operations, fault population analysis may be performed in simulations using the fault model, using one or more modules of the signal processing engine, on the model (e.g., 3-dimensional triangulated fault model). In particular, a series of computations may be performed on the one or more models (e.g., fault models) to quantify the fault model characteristics of the fault model. These model characteristics comprise attribute data that enable: application of a screening process to a large ensemble of fault models, and effective execution of ranking processes and/or sorting processes using the large ensemble of fault models based on the fault model characteristics such as isolated fault proportion data associated with one or more geological faults, fault topology distribution data associated with one or more geological faults, fault size distribution data associated with one or more geological faults, etc. Multiple fault model outputs may be screened within a series of plots/graph representations with the purpose of identifying and selecting key connectivity metrics that separate distinct and meaningful fault model scenarios from the wider ensemble. Each selected fault model may then be ‘flagged’ for later use in the construction of a full subsurface framework model. Additional details of the uncertainty and sensitivity workflow can be found in associated IP disclosure entitled: A method for analyzing the uncertainty and sensitivity of ML/AI generated fault populations.

With the application of machine-learning techniques, a high number of faults may be generated for the one or more models. An exemplary workflow using machine-learning techniques as presented in this disclosure can generate at least 500 faults. This solution automatically computes accurate geometrical fault attributes on a grid (e.g., per-triangle or per-hexcell, or other gridding solutions) basis once the fault model is generated. These fault attributes may be subsequently used to split the fault population into fault groups based on user-specified parameterizations. The fault grouping mechanism may allow a user to handle, visualize, and execute quality control operations on large numbers of faults in a highly efficient or optimal manner, further reducing workflow cycle time. Data clustering techniques may be used to automate this fault grouping. In some embodiments, the term optimal and its variants (e.g., efficient, optimally, etc.) may simply indicate improving, rather than the ultimate form of ‘perfection’ or the like.

The uncertainty inherent in the fault interpretation results associated with the one or more models may be significant according to some embodiments. Due to the highly manual and time-intensive nature of traditional seismic fault interpretation, and also due to the disjoined nature of workflows when using multiple applications, the variability of fault frameworks is often under-tested and consequently it is typical that only one version or scenario of a fault framework is progressed. With the integration and automation that underpins the disclosed technology, the one or more modules of the signal processing engine may test multiple scenarios of fault models thereby ensuring that the uncertainty space is more extensively sampled and analyzed. Moreover, the disclosed system enables user interaction and editing operations by users at various stages as needed. Furthermore, the disclosed system enables tracking of said user interaction and/or editing operations for legacy purposes and to preserve automation integrity associated with one or more models. As an example, if a user performs edits to a particular model element (e.g., model object) such as a particular fault connection within a fault model, this edit may be tracked within the system and made repeatable. Through the use of this tracking mechanism, the disclosed system enables updates to be automatically made in any preceding step of the editing operation without breaking the chain of automation. Furthermore, while leveraging this automated system, the disclosed solution supports the creation of multiple fault framework configurations (e.g., fault extensions and fault-fault intersections) with associated reservoir compartmentalization scenarios. These scenarios may serve as alternative subsurface representations, and when subsequently integrated with geological screening and reservoir simulation workflows for field development planning operations, they add important value to the subsurface analysis by enabling quantification of the impact of each framework on reservoir behavior.

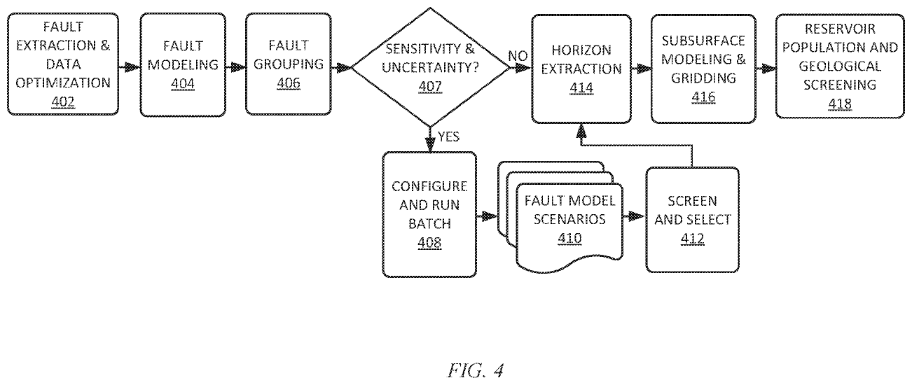

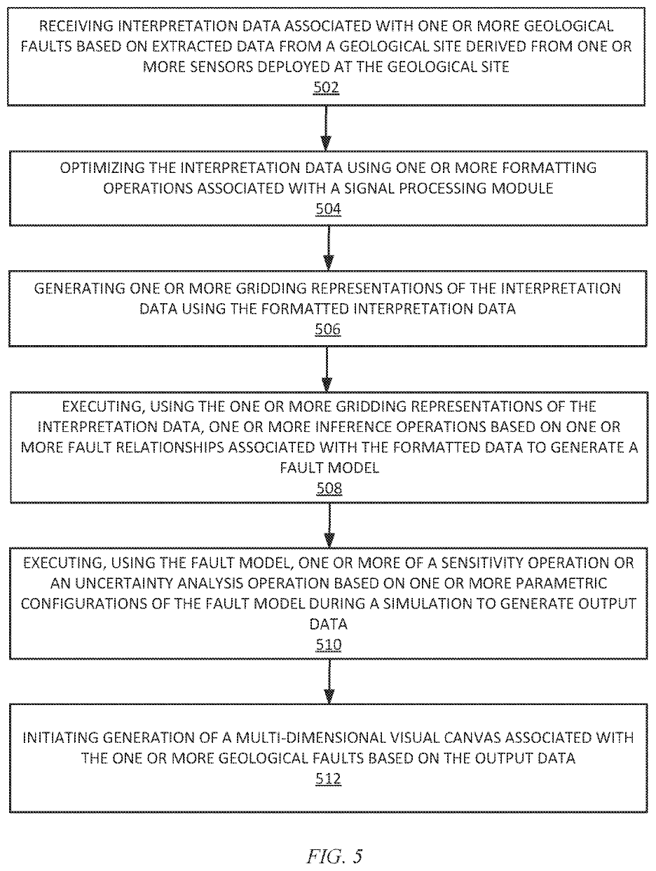

FIG. 4 provides an exemplary workflow for fault extraction from a machine-learned input through to reservoir population and geological screening on the resulting grid(s) as part of the wider modeling workflow (e.g., Agile Reservoir Modelling workflow). This workflow may comprise intervention and interaction operations with objects associated with one or more models in the system while preserving automation integrity. Exemplified in this particular workflow is the branching at a decision point 407 after the execution of steps 402-406 thereby providing the user with the ability to explore sensitivity and uncertainty operations surrounding both the input data and the extraction parameterization(s). In particular, if there are no sensitivity or uncertainty issues, the workflow takes the path indicated by blocks 414, 416, and 418. On the other hand if sensitivity or uncertainty tests are required, the workflow takes the path indicated by on the fault groupings at block 406, the workflow takes the path indicated by blocks 408, 410, 412, before branching to the horizon extraction block 414. These aspects are further clarified in FIG. 5.

FIG. 5 provides an exemplary workflow for methods, systems, and computer programs for fault modeling of a geological formation. It is appreciated that a data managing module stored in a memory device may cause a computer processor to execute the various processing stages of FIG. 5. For example, the disclosed techniques may be implemented as a signal processing engine/module or a data manager within a geological software tool such that the signal processing engine enables the modeling of geological structures in the subsurface of a resource site based on the processes outlined herein.

At block 502, the signal processing engine may receiving interpretation data associated with one or more geological faults based on extracted data from a geological site derived from one or more sensors deployed at the geological site. The interpretation data may comprise seismic fault data captured by the one or more sensors deployed at the geological site. At block 504, the signal processing engine may optimize the interpretation data using one or more formatting operations associated with a signal processing engine. The one or more formatting operations may comprise at least one of: a splitting operation on data associated with fault patches within parameter constraints of the interpretation data; a merging operation on data associated with fault patches within parameter constraints of the interpretation data; a filtering operation on the interpretation data to remove noisy components; and a decimation operation to sample certain specific data components of the interpretation data. At block 506, the signal processing engine may generate one or more gridding representations of the interpretation data using the formatted interpretation data. The one or more gridding representations, according to one embodiment, includes triangle mesh representations. In other embodiments, the one or more gridding representations include hexcell representations.

Turning to block 508 of FIG. 5, the signal processing engine may execute, using the one or more gridding representations of the interpretation data, one or more inference operations based on one or more fault relationships associated with the formatted data to generate a fault model. One or more characteristics associated with the fault model comprises attribute data that enable: application of a screening process to a large ensemble of fault models; and execution of a ranking process or a sorting process using the large ensemble of models based on the one or more characteristics. The one or more characteristics of the fault model, according to one embodiment, comprises one or more of: isolated fault proportion data associated with the one or more geological faults; fault topology distribution data associated with the one or more geological faults; and fault size distribution data associated with the one or more geological faults.

At block 510, the signal processing engine may execute, using the fault model, one or more of a sensitivity operation or an uncertainty analysis operation based on one or more parametric configurations of the fault model during a simulation to generate output data. According to one embodiment, the one or more of the sensitivity operation or the uncertainty operation comprises quantifying one or more characteristics associated with the fault model such as the characteristics discussed above. Moreover, executing one or more of the sensitivity operation or the uncertainty analysis operation may comprise perturbing one or more parameters of the fault model to determine one or more outcomes for the extracted data. In addition, the one or more parameters may include at least one of: a fault probability input threshold parameter indicating range data associated with input fault cube samples associated with the one or more geological faults; an azimuth sector size parameter indicating data of individual sectors associated with the one or more geological faults; and an azimuth sector overlap parameter indicating of one or more overlaps between azimuth sectors associated with the one or more geological faults. In some embodiments, the one or more parameters include at least one of: a planarity threshold parameter indicating threshold data that describes the one or more geological faults as geometrically consistent; a minimum fault size (per sector) parameter indicating data of a minimum fault size in number of samples associated with the one or more geological faults; a minimum overlap parameter indicating data of a minimum amount, by percentage, that the one or more geological faults in adjacent sectors must overlap by to be considered for merging operations. At block 512, the signal processing engine may initiate generation of a multi-dimensional visual canvas associated with the one or more geological faults based on the output data. The multi-dimensional visual canvas, according to one embodiment, comprises a 3-dimensional visual canvas or a 2-dimensional visual canvas associated with the one or more geological faults.

Exemplary needs addressed by the disclosed technology include:
an inability to users to appreciate or otherwise understand quality of fault interpretation data specifically for use in fault modelling due to a lack of immediate consumption into a fault framework model;
difficulties associated with managing large numbers of fault objects in a logical manner through grouping or clustering workflows;
difficulties in understanding extraction parameterizations as such processes require specific expertise to optimize results;
inability to automate data associated with fault interpretation and modeling making testing of uncertainty challenging and discourages users (e.g., domain geoscientists) from promoting more than one version of a fault framework.

Moreover, the disclosed technology provides one or more of the following advantages:
integration of interpretation and modelling steps into one process flow thereby allowing a user to visualize and perform quality control operations using one or more workflows disclosed on the fault model;
provision of grouping mechanisms that handle a relatively large number of fault objects associated with one or more fault models for efficient user interaction and editing;
embedded sensitivity and analysis workflows within the fault extraction process to eliminate the need for high levels of expertise and to reduce cognitive load;
augmented workflow automation processes across one or more end-to-end workflows and branching disclosed to enable the generation of scenarios that test uncertainty;
efficient fault model construction for the purposes of building subsurface reservoir models for extractive or storage activities;
seamless integration of the disclosed signal processing engine into third-party application systems designed to detect discontinuities from a machine-learning derived input;
ability to derive a fault model immediately (in real-time or near real-time) from the execution of the fault extraction process;
ability to handle large numbers of ML-derived faults an efficient and optimal manner;
little to no prior knowledge of fault extraction parameterization data is required to run workflow and produce insightful result sets;
provision of a signal processing engine (e.g., an application) which encourages a user to test uncertainty inherent across all aspects of the fault interpretation to model workflow and efficiently branch to generate multiple representations of the fault framework model;
enablement of a user (e.g., domain geoscientist) to directly construct multiple fault framework scenarios having meaningful and unique characteristics, in an efficient manner, directly from machine-learning derived data indicating fault prediction or fault attribute volumes, using a single platform (e.g., single signal processing engine).

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to use the invention and various embodiments with various modifications as are suited to the particular use contemplated.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for fault modeling of a geological formation, the method comprising:
receiving, using a computer processor, interpretation data associated with one or more geological faults based on extracted data from a geological site derived from one or more sensors deployed at the geological site;
optimizing, using the computer processor, the interpretation data using one or more formatting operations associated with a signal processing module;
generating, using the computer processor, one or more gridding representations of the interpretation data using the formatted interpretation data;
executing, using the computer processor and the one or more gridding representations of the interpretation data, one or more inference operations based on one or more fault relationships associated with the formatted data to generate a fault model;
executing, using the computer processor and the fault model, one or more of a sensitivity operation or an uncertainty analysis operation based on one or more parametric configurations of the fault model during a simulation to generate output data; and
initiating, using the computer processor, generation of a multi-dimensional visual canvas associated with the one or more geological faults based on the output data.

2. The method of claim 1, wherein the one or more formatting operations comprise at least one of:
a splitting operation on data associated with fault patches within parameter constraints of the interpretation data;
a merging operation on data associated with fault patches within parameter constraints of the interpretation data;
a filtering operation on the interpretation data to remove noisy components; and
a decimation operation to sample certain specific data components of the interpretation data.

3. The method of claim 1, wherein executing one or more of the sensitivity operation or uncertainty analysis operation comprises perturbing one or more parameters of the model to determine one or more outcomes for the extracted data.

4. The method of claim 3, wherein the one or more parameters include at least one of:
a fault probability input threshold parameter indicating range data associated with input fault cube samples associated with the one or more geological faults;
an azimuth sector size parameter indicating data of individual sectors associated with the one or more geological faults;
an azimuth sector overlap parameter indicating of one or more overlaps between azimuth sectors associated with the one or more geological faults.

5. The method of claim 3, wherein the one or more parameters include at least one of:
a planarity threshold parameter indicating threshold data that describes the one or more geological faults as geometrically consistent;
a minimum fault size (per sector) parameter indicating data of a minimum fault size in number of samples associated with the one or more geological faults;
a minimum overlap parameter indicating data of a minimum amount, by percentage, that the one or more geological faults in adjacent sectors must overlap by to be considered for merging operations.

6. The method of claim 1, wherein one or more of the sensitivity operation or the uncertainty operation comprises quantifying one or more characteristics associated with the fault model.

7. The method of claim 6, wherein the one or more characteristics associated with the fault model comprises attribute data that enable:
application of a screening process to a large ensemble of fault models; and
execution of a ranking process or a sorting processes using the large ensemble of models based on the one or more characteristics.

8. The method of claim 6, wherein the one or more characteristics comprises one or more of:
isolated fault proportion data associated with the one or more geological faults;
fault topology distribution data associated with the one or more geological faults; and
fault size distribution data associated with the one or more geological faults.

9. The method of claim 1, wherein the one or more gridding representations include triangle mesh representations.

10. The method of claim 1, wherein the one or more gridding representations include hexcell representations.

11. A system for fault modeling of a geological formation, the system comprising:
a computer processor, and
memory storing instructions that are executable by the computer processor to:
receive interpretation data associated with one or more geological faults based on extracted data from a geological site derived from one or more sensors deployed at the geological site;
optimize the interpretation data using one or more formatting operations associated with a signal processing module;
generate one or more gridding representations of the interpretation data using the formatted interpretation data;
execute, using the one or more gridding representations of the interpretation data, one or more inference operations based on one or more fault relationships associated with the formatted data to generate a fault model;
execute, using the fault model, one or more of a sensitivity operation or an uncertainty analysis operation based on one or more parametric configurations of the fault model during a simulation to generate output data; and
initiate generation of a multi-dimensional visualization associated with the one or more geological faults based on the output data.

12. The system of claim 11, wherein the one or more formatting operations comprise at least one of:
a splitting operation on data associated with fault patches within parameter constraints of the interpretation data;
a merging operation on data associated with fault patches within parameter constraints of the interpretation data;
a filtering operation on the interpretation data to remove noisy components; and
a decimation operation to sample certain specific data components of the interpretation data.

13. The system of claim 11, wherein executing one or more of the sensitivity operation or uncertainty analysis operation comprises perturbing one or more parameters of the model to determine one or more outcomes for the extracted data.

14. The system of claim 13, wherein the one or more parameters include at least one of:
a fault probability input threshold parameter indicating range data associated with input fault cube samples associated with the one or more geological faults;
an azimuth sector size parameter indicating data of individual sectors associated with the one or more geological faults;
an azimuth sector overlap parameter indicating of one or more overlaps between azimuth sectors associated with the one or more geological faults.

15. The system of claim 11, wherein one or more of the sensitivity operation or the uncertainty operation comprises quantifying one or more characteristics associated with the fault model.

16-18. (canceled)

19. A computer program comprising instructions, that when executed by a computer processor of a computing device, causes the computing device to:
receive interpretation data associated with one or more geological faults based on extracted data from a geological site derived from one or more sensors deployed at the geological site;
optimize the interpretation data using one or more formatting operations associated with a signal processing module;
generate one or more gridding representations of the interpretation data using the formatted interpretation data;
execute, using the one or more gridding representations of the interpretation data, one or more inference operations based on one or more fault relationships associated with the formatted data to generate a fault model;
execute, using the fault model, one or more of a sensitivity operation or an uncertainty analysis operation based on one or more parametric configurations of the fault model during a simulation to generate output data; and
initiate generation of a multi-dimensional visualization associated with the one or more geological faults based on the output data.

20. The computer program of claim 19, wherein the one or more formatting operations comprise at least one of:
a splitting operation on data associated with fault patches within parameter constraints of the interpretation data;
a merging operation on data associated with fault patches within parameter constraints of the interpretation data;
a filtering operation on the interpretation data to remove noisy components; and
a decimation operation to sample certain specific data components of the interpretation data.

21. The computer program of claim 19, executing one or more of the sensitivity operation or uncertainty analysis operation comprises perturbing one or more parameters of the model to determine one or more outcomes for the extracted data, wherein the one or more parameters include at least one of:
a fault probability input threshold parameter indicating range data associated with input fault cube samples associated with the one or more geological faults;
an azimuth sector size parameter indicating data of individual sectors associated with the one or more geological faults;
an azimuth sector overlap parameter indicating of one or more overlaps between azimuth sectors associated with the one or more geological faults.

22. (canceled)

23. The computer program of claim 19, wherein one or more of the sensitivity operation or the uncertainty operation comprises quantifying one or more characteristics associated with the fault model.

24. (canceled)

25. The computer program of claim 19, wherein the multi-dimensional visualization comprises a 3-dimensional visual canvas associated with the one or more geological faults.

26-27. (canceled)
